(19) United States
(12) Patent Application Publication
(10) Pub. No.: US 2020/0275242 A1
(43) Pub. Date: Aug. 27, 2020

(54) WIRELESS COMMUNICATION SYSTEM AND COMPUTER PROGRAM PRODUCT

(71) Applicant: FUJITSU CLIENT COMPUTING LIMITED, Kanagawa (JP)

(72) Inventor: Keita Satou, Kawasaki (JP)

(73) Assignee: FUJITSU CLIENT COMPUTING LIMITED, Kanagawa (JP)

(21) Appl. No.: 16/782,718

(22) Filed: Feb. 5, 2020

(30) Foreign Application Priority Data
Feb. 21, 2019 (JP) 2019-029486

(51) Int. Cl. H04W 4/08; H04W 4/80; H04W 76/11; H04W 80/12

(52) U.S. Cl. CPC H04W 4/08; H04W 80/12; H04W 76/11; H04W 4/80

(57) ABSTRACT

A wireless communication system includes an information processing device and wireless communication devices for communicating with the information processing device by wireless communication. The information processing device includes a first storage unit and processing circuitry that implements a transmission control unit. The first storage unit stores therein first information in which feature values of feature items of targets each including one of the wireless communication devices are associated with group identification information on groups to which the feature values belong. The transmission control unit transmits an instruction code including group identification information common to targets each including one of wireless communication devices to be driven, to the wireless communication devices.

### CROSS-REFERENCE TO RELATED APPLICATIONS

This application is based upon and claims the benefit of priority from Japanese Patent Application No. 2019-029486, filed Feb. 21, 2019, the entire contents of which are incorporated herein by reference.

### FIELD

Embodiments described herein relate generally to a wireless communication system and a computer program product.

### BACKGROUND

Radio frequency identification (RFID) systems for communicating with a plurality of wireless communication devices in a wireless manner have been known. A system for transmitting a wireless signal to a particular wireless communication device to drive the particular wireless communication device has been known.

Conventionally, however, a single particular wireless communication device can be selectively driven, but it is difficult to drive a plurality of wireless communication devices simultaneously.

### SUMMARY

According to an aspect of the present invention, a wireless communication system includes an information processing device and wireless communication devices for communicating with the information processing device by wireless communication. The information processing device includes a first storage unit and processing circuitry. The first storage unit stores therein first information in which feature values of feature items of targets each including one of the wireless communication devices are associated with group identification information on groups to which the feature values belong. The processing circuitry configured to implement a transmission control unit for transmitting an instruction code including group identification information common to targets each including one of wireless communication devices to be driven, to the wireless communication devices capable of wireless communication. Each wireless communication device includes a second storage unit and processing circuitry. The second storage unit stores therein group identification information on groups to which feature values of the feature items of a target including the wireless communication device belong, as a call code for the wireless communication device. The processing circuitry is configured to implement an acquisition unit and a drive control unit. The acquisition unit acquires the instruction code. The drive control unit drives a drive unit in the wireless communication device, when the group identification information included in the acquired instruction code matches the call code.

According to another aspect of the present invention, a computer program product includes programmed instructions embodied in and stored on a non-transitory computer readable medium. The instructions, when executed by a computer that communicates with wireless communication devices by wireless communication, cause the computer to perform transmitting an instruction code including group identification information on groups to which feature values of feature items of targets each including one of wireless communication devices to be driven belong, the group identification information being common to the targets, to each of the wireless communication devices capable of wireless communication.

### BRIEF DESCRIPTION OF THE DRAWINGS

FIG. 1 is a schematic diagram illustrating an example of a wireless communication system according to an embodiment;

FIG. 2 is a functional block diagram of the wireless communication system according to the embodiment;

FIG. 3 is a schematic diagram illustrating an example of a data configuration of second information according to the embodiment;

FIG. 4 is a schematic diagram illustrating an example of a data configuration of first information according to the embodiment;

FIG. 5 is a flowchart illustrating an example of the flow of preprocessing executed by an information processing device according to the embodiment;

FIG. 6 is a flowchart illustrating an example of the flow of preprocessing executed by a wireless communication device according to the embodiment;

FIG. 7 is a flowchart illustrating an example of the flow of processing for transmitting an instruction code executed by the information processing device according to the embodiment;

FIG. 8 is a flowchart illustrating an example of the flow of information processing executed by the wireless communication device according to the embodiment; and

FIG. 9 is a hardware configuration diagram of the information processing device, an observation device, and the wireless communication device according to the embodiment.

### DETAILED DESCRIPTION

Exemplary embodiments of the present disclosure are disclosed below. Configurations in the embodiments described below and functions and effects provided by the configurations are illustrative. The following embodiments are not intended to limit the disclosed technology.

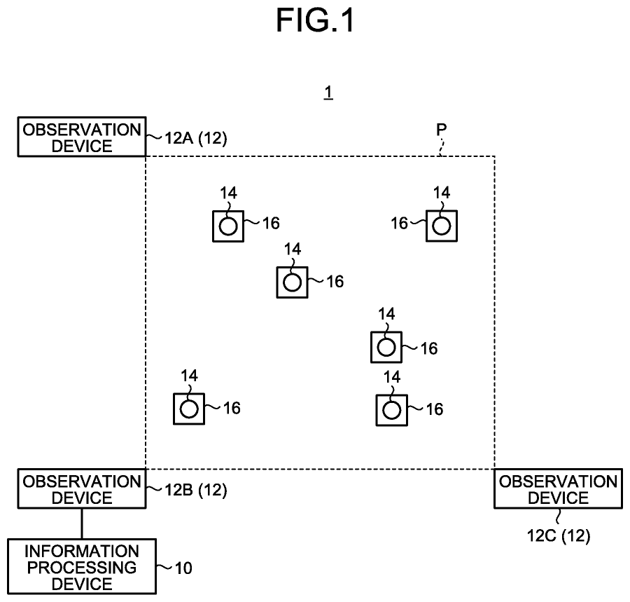

FIG. 1 is a schematic diagram illustrating an example of a wireless communication system 1 in the present embodiment.

The wireless communication system 1 includes an information processing device 10, an observation device 12, and a plurality of wireless communication devices 14 for communicating with the information processing device 10 in a wireless manner. The information processing device 10 and the observation device 12 are communicably connected in a wired or wireless manner.

The information processing device 10 is a device for performing wireless communication with a wireless communication device 14 in a target region P directly or through the observation device 12. The information processing device 10 transmits various kinds of wireless signals such as an instruction code described later to the wireless communication devices 14 in the target region P.

The target region P may be a region set in advance. In the present embodiment, the target region P is a region where one or a plurality of observation devices 12 intend to communicate with a wireless communication device 14 in a wireless manner. The shape and size of the target region P are not limited. The target region P is a region within a predetermined range, such as a building, a space in a building, and a room.

The observation device 12 transmits various kinds of wireless signals to the wireless communication devices 14 in the target region P. The observation device 12 receives wireless signals from the wireless communication devices 14 in the target region P. In other words, the observation device 12 functions as a transmitting station for transmitting wireless signals to the wireless communication devices 14 in the target region P and as a receiving station for receiving wireless signals from the wireless communication devices 14 in the target region P.

In the present embodiment, a configuration in which the wireless communication system 1 includes three observation devices 12 (observation device 12A to observation device 12C) is described as an example. However, the number of the observation devices 12 included in the wireless communication system 1 is not limited to three. In the case where the wireless communication device 14 and the information processing device 10 can directly communicate with each other in a wireless manner, the observation device 12 may be omitted. In the present embodiment, a configuration in which the information processing device 10 communicates with the wireless communication device 14 through the observation device 12 in a wireless manner. In other words, the present embodiment assumes that the communication between the information processing device 10 and the wireless communication device 14 is performed through the wireless communication device 14.

The wireless communication device 14 is a wireless communication device capable of communicating with the information processing device 10 in a wireless manner. As described above, in the present embodiment, the wireless communication device 14 communicates with the information processing device 10 through the observation device 12 in a wireless manner.

For example, the wireless communication device 14 has a function for communication by Bluetooth (registered trademark), and transmits and receives wireless signals based on the wireless communication standard such as Bluetooth Low Energy (BLE). The wireless communication standard used by the wireless communication device 14 is not limited to the form using Bluetooth. For example, the wireless communication device 14 may perform wireless communication by using the infrared communication standard such as Infrared Data Association (IrDA).

The wireless communication device 14 may transmit a wireless signal directly to the observation device 12, or may transmit a wireless signal to the observation device 12 by multi-hop wireless communication. When the wireless signal is transmitted to the observation device 12 by multi-hop wireless communication, the wireless communication device 14 relays another one or a plurality of wireless communication devices 14 and transfers a wireless signal received from the wireless communication device 14 as a signal transmission source to the observation device 12. The observation device 12 outputs the received wireless signal to the information processing device 10.

In the present embodiment, the wireless communication device 14 is provided to a target 16. Specifically, at least one wireless communication device 14 is provided to one target 16. In the present embodiment, a configuration in which one wireless communication device 14 is provided to one target 16 is described as an example.

The target 16 is an object that can mount the wireless communication device 14 thereon. The target 16 may be a living object or a non-living object. Examples of the target 16 include humans, animals, mobile bodies (vehicles, airplanes, and drones), and articles. The articles are, for example, shoes, clothes, and boxes, but are not limited thereto.

The target 16 may be movable or may be immovable. When the target 16 can move, the target 16 may be capable of moving by including a power mechanism, or may be capable of moving by external force, such as by being carried by another target. In the present embodiment, the case where the target 16 can move its position is described as an example.

For example, when the target 16 is an article, one wireless communication device 14 is provided to one article.

Thus, the wireless communication device 14 can move its position when the position of the target 16 moves. The wireless communication device 14 is sometimes called “tag”. The wireless communication device 14 is provided to the target 16 and used to manage the target 16.

Next, the functional configuration of the wireless communication system 1 is described.

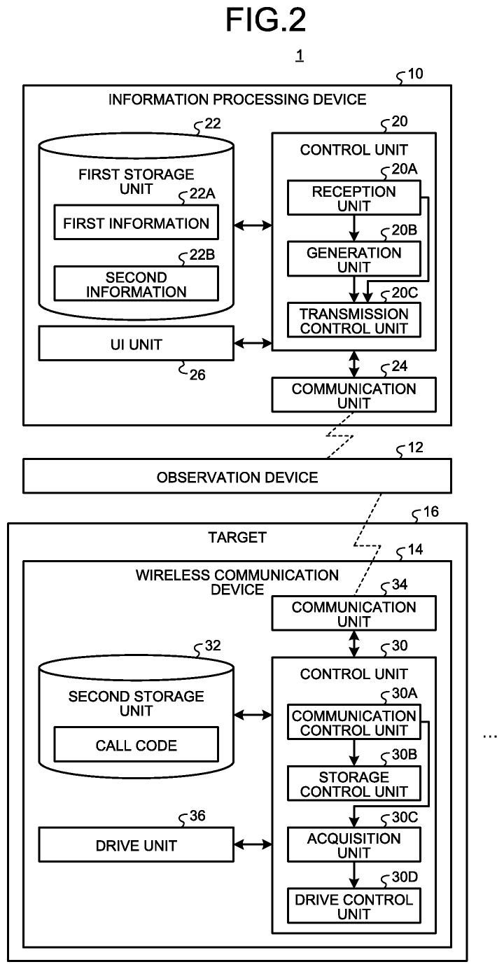

FIG. 2 is an example of a functional block diagram of the wireless communication system 1.

First, the information processing device 10 is described.

The information processing device 10 includes a control unit 20, a first storage unit 22, a communication unit 24, and a user interface (UI) unit 26. The control unit 20, the first storage unit 22, the communication unit 24, and the UI unit 26 are connected such that data or signals can be exchanged.

The first storage unit 22 stores therein various kinds of information therein. In the present embodiment, the first storage unit 22 stores therein first information 22A and second information 22B therein. Details of the information are described later. The first storage unit 22 is a publicly known storage medium, such as a hard disk drive (HDD). The first storage unit 22 may be provided to an external device.

The communication unit 24 is a communication interface for communicating with the observation device 12. The communication unit 24 may be a communication interface for communicating with the observation device 12 and the wireless communication device 14.

The UI unit 26 has an input function for receiving operation instructions from a user and a display function for displaying images. Examples of the input function include a keyboard and a mouse. Examples of the display function include a liquid crystal display device and an organic electroluminescent (EL) display. The UI unit 26 may be a touch panel having the input function and the display function integrally.

The control unit 20 includes a reception unit 20A, a generation unit 20B, and a transmission control unit 20C.

Each of the above-mentioned units is implemented by, for example, one or a plurality of processors. For example, each of the above-mentioned units may be implemented by causing a processor such as a central processing unit (CPU) to execute a computer program, that is, by software. Each of the above-mentioned units may be implemented by a processor such as a dedicated integrated circuit (IC), that is, by hardware. Each of the above-mentioned units may be implemented by a combination of software and hardware. In the case where processors are used, each processor may implement one of the units or may implement two or more of the units.

The reception unit 20A receives target information. The target information includes information on features of the target 16 and identification information on the wireless communication device 14 included in the target 16.

The information on the features of the target 16 is information including one or a plurality of feature items indicating the features of the target 16, and feature values of the feature items.

The features of the target 16 indicate points that can be used to distinguish from other targets 16. Examples of the features of the target 16 include features of the appearance of the target 16, features of the manufacturing of the target 16, features of functions of the target 16, and features provided to the target 16. When the target 16 is shoes, the features of the appearance of the target 16 are, for example, the color and the size. Examples of the features of the manufacturing of the target 16 include a manufacturer, manufacturing conditions, and a seller of the target 16. Examples of the features of functions of the target 16 include the application of the target 16, the voltage of a battery provided to the wireless communication device 14 including the target 16, and the replacement date of the battery. Examples of the features provided to the target 16 include the price of the target 16. The features of the target 16 are not limited thereto.

The feature item is information for specifying a category obtained by categorizing the features of the target 16 into one or a plurality of categories in accordance with predetermined classifying conditions. Examples of the feature items include the color, size, manufacturer, application, price, battery voltage, and replacement date. The feature items of the target 16 are not limited thereto.

The feature value is a value indicating the actual content of the feature item. The feature value may be expressed by any of numerals, characters, and symbols. When the feature item is color, the feature value of the feature item is, for example, blue, red, white, or black. When the feature item is size, the feature value of the feature item is, for example, 25.0, 25.5, 26.0, 26.5, 27.0, 28.0, or 29.0. When the feature item is a manufacturer, the feature value of the feature item is a company A or a company B. When the feature item is application, the feature value of the feature item is football or volley ball. When the feature item is price, the feature value of the feature item is expressed by numerals indicating the amount of money. The feature value is not limited thereto.

The identification information on the wireless communication device 14 included in the target 16 is information for identifying the wireless communication device 14 provided to the target 16. The identification information on the wireless communication device 14 is sometimes called “tag ID”. In the following, the identification information on the wireless communication device 14 is sometimes referred to as “tag ID”.

For example, the reception unit 20A receives target information from the UI unit 26. For example, a user operates the UI unit 26 to input the target information. The reception unit 20A then receives the target information from the UI unit 26. The reception unit 20A may receive the target information by receiving the target information from an external device by wireless communication or wired communication.

The reception unit 20A registers the received target information with the second information 22B.

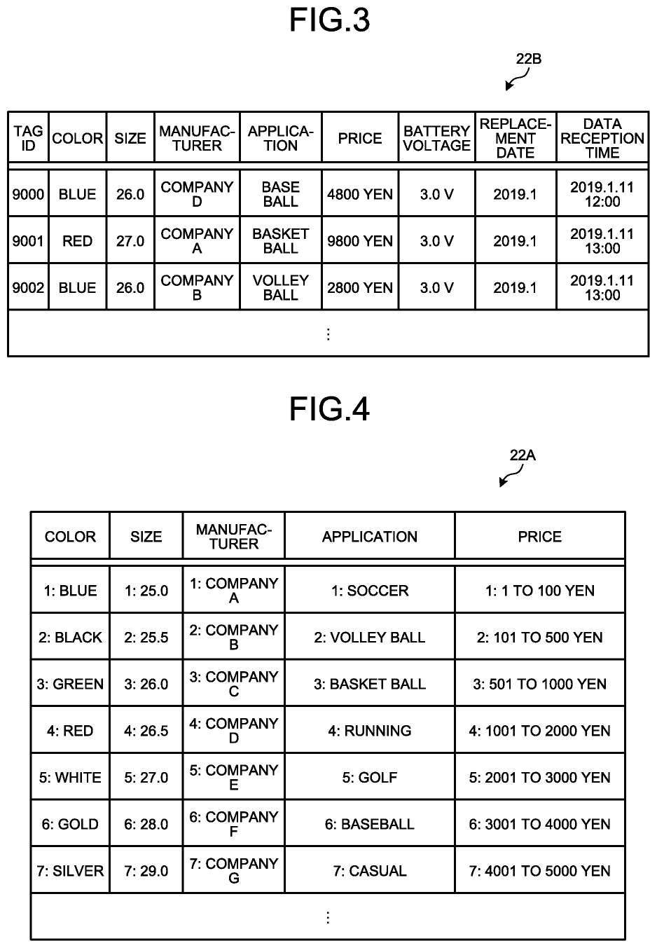

FIG. 3 is a schematic diagram illustrating an example of the data configuration of the second information 22B. FIG. 3 illustrates an example of the data configuration of the second information 22B when the target 16 is “shoes”.

The second information 22B is information in which a tag ID is associated with feature items. The data form of the second information 22B is not limited. For example, the data form of the second information 22B may be a table or a database.

Each time the reception unit 20A receives target information, the reception unit 20A registers a tag ID included in the target information and feature values of feature items included in the target information with the second information 22B in association with each other. The description is given on the assumption that one piece of the target information includes one tag ID and information on the target 16 including the wireless communication device 14 identified by the tag ID.

When the second information 22B is updated by the reception unit 20A, the tag ID of each of the wireless communication devices 14 and the feature value of each of one or a plurality of feature items of each of the targets 16 including the wireless communication devices 14 are registered with the second information 22B. In the present embodiment, the case where the number of feature items indicating features of one target 16 is plural is described as an example. Thus, with the second information 22B, a feature value of each of the feature items is registered for each tag ID. The number of feature items indicating one target 16 may be one. In this case, with the second information 22B, only one feature item (for example, “color”) is registered for each tag ID.

As illustrated in FIG. 3, with the second information 22B, other pieces of information may be further registered in addition to the tag ID and the feature items. For example, with the second information 22B, the time at which the target information was received by the information processing device 10 (data reception time) may be registered.

The reception unit 20A may receive the second information 22B from an external device by wireless communication or wired communication, and store the second information 22B in the first storage unit 22.

Returning to FIG. 2, the description is continued. When the second information 22B is stored in the first storage unit 22, the generation unit 20B generates the first information 22A.

For example, the generation unit 20B may generate the second information 22B when a predetermined number or more of tag IDs and feature values of feature items corresponding to each tag ID are registered with the second information 22B. The generation unit 20B may generate the first information 22A when an instruction to generate the first information 22A is input by the user through an operation instruction on the UI unit 26.

The generation unit 20B only needs to generate the first information 22A after the second information 22B is stored in the first storage unit 22 and before processing for transmitting an instruction code (details are described later) by the transmission control unit 20C described later is started.

The generation of the first information 22A is described.

FIG. 4 is a schematic diagram illustrating the data configuration of the first information 22A. The first information 22A is information in which feature values of feature items of the targets 16 each including the wireless communication device 14 are associated with group identification information on a group to which the feature values belong. In FIG. 4, the numerals on the left side of symbol “:” are an example of the group identification information. The character string on the right side of symbol “:” is an example of the feature value.

The group indicates each group obtained by classifying a plurality of kinds of the feature values indicated for the feature items into a plurality of groups in accordance with predetermined group classifying conditions. The group classifying conditions only need to be set in advance for each feature item.

For example, it is assumed that the kinds of the feature values “blue”, “black”, “green”, “red”, “white”, “gold”, and “silver” of the feature item “color” are classified into groups in accordance with the values of the feature values. In this case, for example, “blue”, “black”, “green”, “red”, “white”, “gold”, and “silver” as colors are classified into different groups.

For example, it is assumed that the kinds of the feature values “1 to 5,000 yen” as the feature item “price” are classified into groups by being sectioned for each predetermined price range. In this case, for example, “1 to 100 yen”, “101 to 500 yen”, “501 to 1,000 yen”, “1,001 to 2,000 yen”, “2,001 to 3,000 yen”, “3,001 to 4,000 yen”, and “4,001 to 5,000 yen” are classified into different groups.

The group identification information is information for identifying the above-mentioned group. For example, as illustrated in FIG. 4, the group identification information is expressed by numerals, such as “1”, “2”, “3”, “4”, “5”, “6”, and “7”. The data format of the group identification information is not limited. For example, the data format of the group identification information may be a text format such as characters and numerals, or may be a binary format. In the present embodiment, the case where the group identification information is in a text format is described as an example.

The generation unit 20B classifies, for each of the feature items indicated in the second information 22B (see FIG. 3), the feature values indicated for the feature items into groups in accordance with the group classifying conditions set in advance for each feature item. The generation unit 20B provides, for each feature item, group identification information to each of the classified groups. The group identification information only needs to be information that can be uniquely identified among the feature items, and the feature items may include group identification information having the same value.

The generation unit 20B registers, for each feature item, the feature value and the group identification information on the group to which the feature value belongs in association with each other to generate the first information 22A. In other words, in the present embodiment, the generation unit 20B stores, in the first storage unit 22, the first information 22A in which the feature value and the group identification information are associated with each other for each of the feature items.

Thus, as illustrated in FIG. 4, in the first information 22A, the feature values and the group identification information (for example, numerals such as “1” to “7”) on a group to which each of the feature values belongs are associated with each other for each of the feature items (for example, “color”, “size”, “manufacturer”, “application”, and “price”) of the target 16 including the wireless communication device 14.

The control unit 20 may receive the first information 22A and the second information 22B from an external device by wireless communication or wired communication, and store the first information 22A and the second information 22B in the first storage unit 22. In this case, the external device may execute the above-mentioned processing to generate the first information 22A and the second information 22B.

Returning to FIG. 2, the description is continued. After the first information 22A and the second information 22B have been stored in the first storage unit 22, the generation unit 20B generates a call code for the wireless communication device 14.

The call code is a code used by the information processing device 10 to call the wireless communication device 14. The call code is composed of the group identification information on the group to which the feature values of the feature items of the target 16 including the wireless communication device 14 belong. Specifically, the call code includes the group identification information on the group to which the feature value of the target 16 including the wireless communication device 14 belongs.

The generation unit 20B uses the first information 22A and the second information 22B to generate a call code for each of the wireless communication devices 14.

The generation unit 20B reads, for each tag ID, a feature value of each of the feature items corresponding to the tag ID from the second information 22B. The generation unit 20B specifies group identification information in the first information 22A that corresponds to the read feature values of the feature items.

The generation unit 20B generates, for each wireless communication device 14, group identification information on a group to which feature values of feature items of the target 16 including the wireless communication device 14 as a call code for the wireless communication device 14.

The generation unit 20B may generate a call code composed of group identification information on one feature item, or may generate a call code composed of group identification information on each of the feature items.

When a call code composed of each piece of the group identification information on one feature item is used, the generation unit 20B generates a call code composed of one piece of the group identification information, that is, one digit.

On the other hand, when a call code composed of group identification information on feature items, the generation unit 20B generates a call code composed of group identification information on the feature items, that is, a plurality of digits.

In this case, the generation unit 20B may generate a call code in which group identification information on a group to which a feature value of each of the feature items belongs is disposed at a digit position set in advance for each feature item.

When the generation unit 20B generates a call code having digits and composed of group identification information on the feature items, it is preferred that the number of digits of the call code and the number of digits of the instruction code described later be the same and equal to or smaller than a predetermined number of digits.

The same number of digits means that the numbers of feature items included in the codes, the kinds of the feature items, and the digit positions of the feature items are the same.

The predetermined number of digits only needs to be equal to or larger than one and equal to or smaller than the predetermined number of digits. The predetermined number of digits, that is, the upper limit of the number of digits is, for example, “5”. The number only needs to be set in advance. When the predetermined number is “5” and the group identification information is expressed by a character string, the call code and the instruction code described later are expressed by character strings of 5 digits. In this case, the call code and the instruction code described later include group identification information on each of the five kinds of feature items.

The kind of the feature item corresponding to each digit position of the call code and the instruction code described later only needs to be set in advance. The kinds of the feature items corresponding to the digit positions are the same between the call code and the instruction code described later.

For example, it is assumed that it is set in advance that the first digit of the call code and the instruction code indicates the feature item “color”, the second digit indicates the feature item “size”, the third digit indicates the feature item “manufacturer”, the fourth digit indicates the feature item “application”, and the fifth digit indicates the feature item “price”.

In this case, the generation unit 20B generates the following call code as a call code for the wireless communication device 14 identified by a tag ID “9000” in the second information 22B.

Specifically, the generation unit 20B reads the feature value of each of the feature items corresponding to the tag ID “9000” (feature value “blue” of feature item “color”, feature value “26.0” of feature item “size”, feature value “company D” of feature item “manufacturer”, feature value “baseball” of feature item “application”, feature value “4,800” yen of feature item “price”, feature value “3.0 V” of feature item “battery voltage”, and feature value “2019.1” of feature item “replacement date”).

The generation unit 20B specifies, for each of the read feature items, group identification information on the read feature value by using the first information 22A. In this case, the generation unit 20B specifies, from the first information 22A, group identification information “1” having the feature value “blue” of the feature item “color”, group identification information “3” having the feature value “26.0” of the feature item “size”, group identification information “4” having the feature value “company D” of the feature item “manufacturer”, group identification information “6” having the feature value “baseball” of the feature item “application”, and group identification information “7” having the feature value “4,800” yen of the feature item “price”.

The generation unit 20B disposes the specified group identification information at the digit position set in advance for each of the feature items as a call code for the wireless communication device 14 identified by the tag ID “9000”, thereby generating a call code “13467”.

Similarly, the generation unit 20B generates a call code for each wireless communication device 14 identified by a tag ID registered with the second information 22B.

The digit positions of the feature items in the call code and the instruction code described later can be appropriately changed by the user through an operation instruction on the UI unit 26. The kinds of feature items, the number of feature items, and the digit positions of feature items constituting the call code and the instruction code described later only need to be set in advance, and can be appropriately changed by the user through an operation instruction on the UI unit 26.

The transmission control unit 20C transmits each of the call codes generated by the generation unit 20B to the wireless communication devices 14 identified by the tag IDs corresponding to the feature values used to generate the call codes through the observation device 12. In the present embodiment, the transmission control unit 20C transmits a call code registration instruction signal including the call code and an instruction to register the call code to the wireless communication device 14.

In this manner, the transmission control unit 20C transmits, before the transmission processing for transmitting an instruction code described later to the wireless communication device 14 is executed, the call code registration instruction signal including the call code generated for each wireless communication device 14 to the wireless communication device 14 in advance.

When the first information 22A and the second information 22B are stored in the first storage unit 22 and the transmission control unit 20C transmits the call code registration instruction signal to the wireless communication device 14, the preprocessing before the transmission processing of the instruction code is finished. In other words, the call code is stored in each of the wireless communication devices 14 in advance before the transmission processing of the instruction code is executed. In the first storage unit 22 in the information processing device 10, the first information 22A and the second information 22B are stored in advance before the transmission processing of the instruction code is executed.

Then, the reception unit 20A becomes ready to receive selection of the group identification information on a target to be driven.

In the present embodiment, the reception unit 20A receives, from the UI unit 26, selection of the group identification information on the targets 16 each including the wireless communication device 14 to be driven. For example, it is assumed that among the wireless communication devices 14 managed by the wireless communication system 1, a user wants to simultaneously call a plurality of the wireless communication devices 14 satisfying particular conditions. The wireless communication devices 14 managed by the wireless communication system 1 are wireless communication devices 14 whose tag IDs have been registered with the second information 22B and to which the call codes have been transmitted.

For example, the user operates the UI unit 26 to select, for each feature item, the group to which the feature values common to the targets 16 each including the wireless communication device 14 to be driven belong.

For example, the control unit 20 displays an image indicating the first information 22A on the UI unit 26. Specifically, the control unit 20 displays a list of the feature values and the group identification information on the feature items set in advance for each of the digit positions constituting the call code in the first information 22A on the UI unit 26. In the present embodiment, the first information 22A is displayed on the UI unit 26.

The user checks the displayed first information 22A to select, for each feature item, the group to which the feature values common to the targets 16 including each of the wireless communication devices 14 to be driven belong.

The reception unit 20A receives the group identification information selected for each feature item from the UI unit 26 through the reception unit 20A.

For example, it is assumed that the user wants to drive the wireless communication device 14 provided to the target 16 having the feature value “blue” of the feature item “color” and the feature value “26.0” of the feature item “size”. In this case, the user operates the UI unit 26 to select the group identification information “1” on the group to which the feature value “blue” of the feature item “color” and the group identification information “3” on the group to which the feature value “26.0” of the feature item “size” belongs.

Thus, in this case, the transmission control unit 20C selects the group identification information “1” on the feature item “color” and the group identification information “3” on the feature item “size” from the reception unit 20A through the UI unit 26.

The generation unit 20B disposes the group identification information received by the reception unit 20A at the digit position set in advance for each feature item, thereby generating the instruction code.

There may be a case where a user desires to generate an instruction code by using group identification information on some of the feature items instead of using all feature items set in advance for each of the digit positions constituting a call code. In other words, there may be a case where the user desires to simultaneously call wireless communication devices 14 by using some of the feature items instead of using all feature items set in advance for each of the digit positions of the call code.

In this case, as described above, the group identification information is not selected for a feature items that is not to be retrieved for the calling. Thus, there may be a case where the reception unit 20A does not receive the group identification information on some of the feature items among the feature items set in advance for each of the digit positions constituting the call code.

In this case, the generation unit 20B only needs to dispose a wildcard indicating all pieces of group identification information at a corresponding digit position for a feature item whose selection has not been received from the UI unit 26 through the reception unit 20A.

For example, as described above, it is assumed that the generation unit 20B has received the group identification information “1” on the feature item “color” and the group identification information “3” on the feature item “size” from the UI unit 26 through the reception unit 20A.

In this case, the generation unit 20B disposes the group identification information “1” on the feature item “color” at the first digit, the group identification information “3” on the feature item “size” at the second digit, and a wildcard at a digit position of an unselected feature item. Thus, in this case, the transmission control unit 20C generates an instruction code “13000”. In other words, in this case, at least one piece of the group identification information included in the instruction code is expressed by a wildcard. An example of a special character indicating the wildcard is “0”, and the expression is not limited thereto.

The transmission control unit 20C executes processing for transmitting the instruction code generated by the generation unit 20B to each of the wireless communication devices 14 with which the information processing device 10 can communicate in a wireless manner. Being capable of wireless communication refers to the state in which the information processing device 10 can perform wireless communication directly or through the observation device 12.

Specifically, the transmission control unit 20C transmits the instruction code including the group identification information common to the targets 16 each including each of the wireless communication devices 14 to be driven to each of the wireless communication devices 14 capable of wireless communication. In other words, in the present embodiment, the transmission control unit 20C transmits an instruction code in which the group identification information on each of the feature items common to the targets 16 each including the wireless communication device 14 to be driven is disposed at the digit position set in advance for each feature item to each of the wireless communication devices 14 capable of wireless communication.

In the present embodiment, the transmission control unit 20C transmits the generated instruction code to all wireless communication devices 14 in the target region P through the observation device 12. Thus, the instruction code indicated by the group identification information corresponding to the features of the target 16 including the wireless communication device 14 to be driven is transmitted to the wireless communication device 14. Even in the case where the driving of the wireless communication device 14 is to be stopped, the transmission control unit 20C only needs to transmit the same code to the wireless communication device 14.

Next, the functions of the wireless communication device 14 are described.

The wireless communication device 14 includes a control unit 30, a second storage unit 32, a communication unit 34, and a drive unit 36. The control unit 30, and the second storage unit 32, the communication unit 34, and the drive unit 36 are connected such that data or signals can be exchanged.

The second storage unit 32 stores therein various kinds of information therein. In the present embodiment, the second storage unit 32 stores therein a call code received from the information processing device 10 through the observation device 12. The second storage unit 32 is a publicly known storage medium.

The communication unit 34 is a communication interface for communicating with other devices. For example, the communication unit 34 is a communication interface for performing wireless communication with at least one of the observation device 12, other wireless communication devices 14, and the information processing device 10.

The drive unit 36 drives the wireless communication device 14. The driving refers to generating state change that can be perceived by a user through physical feelings in the wireless communication device 14, such as emission of light, output of sound, generation of vibration, and change in form. The change in form means changing of at least one of the color, shape, and size.

The drive unit 36 has a function for generating the state change in the wireless communication device 14. Examples of the drive unit 36 include a lighting, a speaker, a vibration device, and a drive mechanism for the change in form. The drive unit 36 only needs to be a device for implementing at least one of the emission of light, output of sound, generation of vibration, and change in form.

The control unit 30 includes a communication control unit 30A, a storage control unit 30B, an acquisition unit 30C, and a drive control unit 30D.

Each of the above-mentioned units is implemented by, for example, one or a plurality of processors. For example, each of the above-mentioned units may be implemented by causing a processor such as a CPU to execute a computer program, that is, by software. Each of the above-mentioned units may be implemented by a processor such as a dedicated IC, that is, by hardware. Each of the above-mentioned units may be implemented by a combination of software and hardware. In the case where processors are used, each processor may implement one of the units or may implement two or more of the units.

The communication control unit 30A receives a call code registration instruction signal from the information processing device 10 through the observation device 12 and the communication unit 34.

When the communication control unit 30A receives the call code registration instruction signal, the storage control unit 30B stores a call code included in the call code registration instruction signal in the second storage unit 32. Thus, in the wireless communication device 14, a call code composed of group identification information belonging to feature values of the target 16 including the wireless communication device 14 is registered. In other words, the call code is stored in the second storage unit 32 in advance.

The communication control unit 30A receives an instruction code from the information processing device 10 through the observation device 12 and the communication unit 34.

When the communication control unit 30A receives the instruction code, the acquisition unit 30C acquires the instruction code from the communication control unit 30A.

The drive control unit 30D determines whether the instruction code acquired by the acquisition unit 30C matches the call code stored in the second storage unit 32.

Specifically, when the call code and the instruction code are expressed by a plurality of digits, the instruction code and the call code are compared for each value at the same digit position, and when it is determined that the values at all digit positions are the same, the drive control unit 30D determines that the call code and the instruction code match each other.

As described above, there is a case where the value at at least one digit position of the instruction code is expressed by a wildcard. In this case, the drive control unit 30D specifies a digit position indicated by the wildcard in the instruction code, and determines that the values at the digit positions are the same even when the digit position specified in the call code has any value.

When the drive control unit 30D determines that the instruction code matches the call code, the drive control unit 30D drives the drive unit 36.

Specifically, when the instruction code received from the information processing device 10 matches the call code stored in the second storage unit 32, the drive control unit 30D controls the drive unit 36 so as to implement at least one of the emission of light, output of sound, generation of vibration, and change in form.

Thus, the wireless communication devices 14 that store therein the call code matching the instruction code transmitted by the information processing device 10 are simultaneously driven. Thus, the information processing device 10 can easily simultaneously drive the wireless communication devices 14.

For example, it is assumed that the transmission control unit 20C in the information processing device 10 generates the instruction code “13000” based on the first information 22A and the second information 22B, and transmits the instruction code “13000” to each of the wireless communication devices 14 that can be communicated in a wireless manner. As described above, the instruction code “13000” indicates the group identification information “1” on the feature item “color”, the group identification information “3” on the feature item “size”, and the group identification information on the feature items “manufacturer”, “application”, and “price” having “0” as a wildcard.

In this case, among the wireless communication devices 14 that have received the instruction code “13000”, a plurality of the wireless communication devices 14 in which the first position of the call code is “1” and the second position of the digit position is “3” are driven. Specifically, a plurality of the wireless communication devices 14 provided to the targets 16 in which the feature item “color” is “blue” indicated by the group identification information “1” and the feature item “size” is “26.0” indicated by the group identification information “3” are simultaneously driven.

In this manner, in the wireless communication system 1 in the present embodiment, the wireless communication devices 14 can be easily simultaneously driven.

Next, the flow of information processing executed by the wireless communication system 1 is described.

First, an example of the flow of preprocessing executed by the wireless communication system 1 is described. The preprocessing is processing executed before the information processing device 10 performs the processing for transmitting an instruction code.

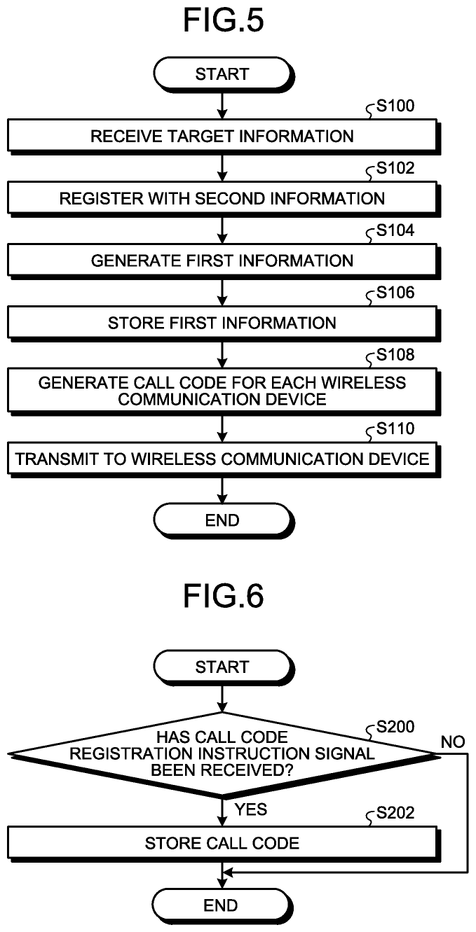

FIG. 5 is a flowchart illustrating an example of the flow of preprocessing executed by the information processing device 10.

The reception unit 20A in the information processing device 10 receives target information from the UI unit 26 (Step S100). The reception unit 20A registers the target information received at Step S100 with the second information 22B (Step S102).

The generation unit 20B uses the second information 22B stored in the first storage unit 22 to generate the first information 22A (Step S104). The generation unit 20B generates the first information 22A by registering, for each feature item, a feature value and group identification information on a group to which the feature value belongs in association with each other. The generation unit 20B stores the generated first information 22A in the first storage unit 22 (Step S106).

Next, the generation unit 20B uses the first information 22A and the second information 22B to generate a call code for each of the wireless communication devices 14 (Step S108).

The transmission control unit 20C transmits each of the call codes generated at Step S108 to a wireless communication device 14 identified by a tag ID corresponding to the feature value used to generate the call code (Step S110). As described above, in the present embodiment, the transmission control unit 20C transmits a call code registration instruction signal including the call code and an instruction to register the call code to the wireless communication device 14. This routine is finished.

FIG. 6 is a flowchart illustrating an example of the flow of preprocessing executed by the wireless communication device 14.

The acquisition unit 30C in the wireless communication device 14 determines whether a call code registration instruction signal has been received from the information processing device 10 (Step S200). When it is determined that the call code registration instruction signal has not been received (No at Step S200), this routine is finished.

On the other hand, when it is determined that the call code registration instruction signal has been received (Yes at Step S200), the flow proceeds to Step S202. At Step S202, the storage control unit 30B stores the call code included in the call code registration instruction signal received at Step S200 in the second storage unit 32 (Step S202). Thus, in the wireless communication device 14, the call code composed of the group identification information belonging to the feature values of the target 16 including the wireless communication device 14 is registered. This routine is finished.

Next, an example of the flow of the processing for transmitting an instruction code executed by the wireless communication system 1 is described.

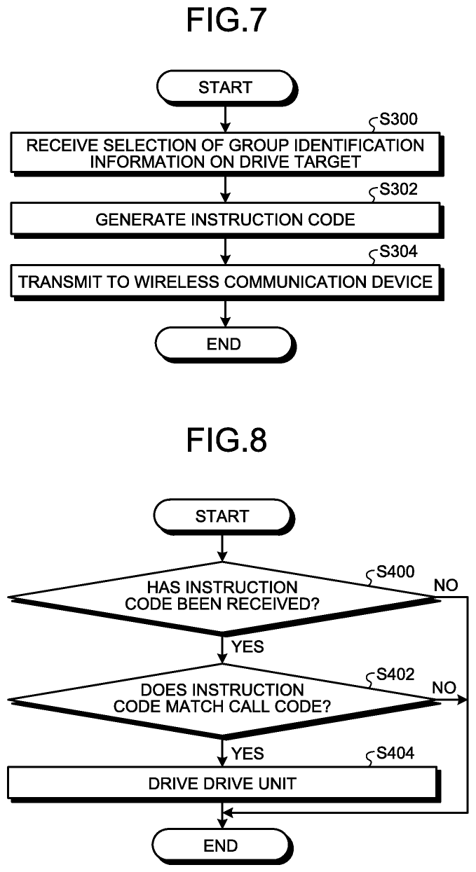

FIG. 7 is a flowchart illustrating an example of the flow of the processing for transmitting an instruction code executed by the information processing device 10 is described.

In response to an operation instruction on the UI unit 26 made by the user, the reception unit 20A in the information processing device 10 receives group identification information selected for each feature item from the UI unit 26 through the reception unit 20A (Step S300). Through the selection at Step S300, the reception unit 20A receives the selection of the group identification information on the target 16 including the wireless communication device 14 to be driven.

The generation unit 20B disposes the group identification information received at Step S300 at a digit position set in advance for each feature item, thereby generating an instruction code (Step S302).

The transmission control unit 20C transmits the instruction code generated at Step S302 to all wireless communication devices 14 in the target region P through the observation device 12 (Step S304). This routine is finished.

FIG. 8 is a flowchart illustrating an example of the flow of information processing executed by the wireless communication device 14. FIG. 8 is an example of information processing executed by the wireless communication device 14 when the information processing device 10 executes the processing for transmitting an instruction code.

The acquisition unit 30C in the wireless communication device 14 determines whether the acquisition unit 30C has acquired an instruction code (Step S400). The acquisition unit 30C makes the determination at Step S400 by determining whether the communication control unit 30A has received an instruction code from the information processing device 10 through the communication unit 34 and the observation device 12.

When the communication control unit 30A has not acquired an instruction code (No at Step S400), this routine is finished. On the other hand, when it is determined that the instruction code has been acquired (Yes at Step S400), the flow proceeds to Step S402.

At Step S402, the drive control unit 30D determines whether the instruction code acquired at Step S400 matches a call code stored in the second storage unit 32 (Step S402). When it is determined that the instruction code does not match the call code (No at Step S402), this routine is finished. On the other hand, when it is determined that the instruction code matches the call code (Yes at Step S402), the flow proceeds to Step S404.

At Step S404, when the instruction code received from the information processing device 10 and the call code stored in the second storage unit 32 match each other, the drive control unit 30D controls the drive unit 36 so as to implement at least one of the emission of light, output of sound, generation of vibration, and change in form (Step S404). This routine is finished.

As described above, the wireless communication system 1 in the present embodiment includes the information processing device 10, and a plurality of wireless communication devices 14 that communicate with the information processing device 10 in a wireless manner. The information processing device 10 includes the first storage unit 22 and the transmission control unit 20C. The first storage unit 22 stores therein the first information 22A in which the feature values of the feature items of the targets 16 each including the wireless communication devices 14 are associated with the group identification information on the group to which the feature values belong. The transmission control unit 20C transmits an instruction code including the group identification information common to the targets 16 including the wireless communication devices 14 to be driven to each of the wireless communication devices 14 capable of wireless communication.

The wireless communication device 14 includes the second storage unit 32, the acquisition unit 30C, and the drive control unit 30D. The second storage unit 32 stores therein the group identification information on the group to which the feature values of the feature items of the target 16 including the wireless communication device 14 belong as a call code for the wireless communication device 14. The acquisition unit 30C acquires the instruction code. When the group identification information included in the acquired instruction code matches the call code, the drive control unit 30D drives the drive unit 36 provided to the wireless communication device 14.

In the conventional technology, a single particular wireless communication device can be selectively driven, but it is difficult to simultaneously drive a plurality of wireless communication devices.

For example, there is a case where a wireless communication device is mounted to a target 16, such as a tray holding baggage, a lost thing, or an article, and a particular wireless communication device is driven at remote, so as to specify the position of the target 16 mounting the wireless communication device thereon or call a user that has held the target 16. In this case, it may be necessary to call a plurality of wireless communication devices simultaneously. Examples of the case include a case of simultaneously moving a plurality of targets 16 such as baggage and a case of simultaneously drawing attention to users that have held a plurality of targets 16.

In the conventional technology, however, signals are sequentially transmitted to wireless communication devices to be called to drive the wireless communication devices, and hence it is difficult to simultaneously drive the wireless communication devices.

In another conventional technology, a plurality of targets 16 are classified into a plurality of groups in advance, and the same identification information (tag ID) is allocated for each group and managed, so that wireless communication devices 14 provided to the targets 16 belonging to the group are simultaneously called. In the conventional technology, however, only the wireless communication devices 14 belonging to a particular group set in advance can be simultaneously driven, and the wireless communication devices 14 to be called are fixed. Moreover, in the conventional technology, the number of wireless communication devices 14 to be simultaneously driven is limited.

Thus, in the conventional technology, a particular single wireless communication device can be selectively driven, but it is difficult to simultaneously drive a plurality of wireless communication devices.

On the other hand, in the wireless communication system 1 in the present embodiment, the information processing device 10 transmits an instruction code including group identification information common to targets 16 each including a wireless communication device 14 to be driven to each of the wireless communication devices 14 capable of wireless communication. In the wireless communication device 14, when the group identification information included in the acquired instruction code matches the call code stored in the wireless communication device 14, the drive unit 36 provided to the wireless communication device 14 is driven.

In this manner, in the wireless communication system 1 in the present embodiment, the group identification information on the group to which the feature values of the feature items of the target 16 including the wireless communication device 14 is used as a call code for the wireless communication device 14, and is stored in the wireless communication device 14 in advance. In the information processing device 10, an instruction code including the group identification information common to the targets 16 each including the wireless communication device 14 to be driven to each of the wireless communication devices 14. In the wireless communication device 14, when the acquired instruction code matches the call code stored in advance, the drive unit 36 in the wireless communication device 14 is driven.

Thus, in the wireless communication system 1 in the present embodiment, the wireless communication devices 14 in which the call code matching the instruction code transmitted by the information processing device 10 can be simultaneously driven.

Consequently, the wireless communication system 1 in the present embodiment can simultaneously drive the wireless communication devices 14.

In the wireless communication system 1 in the present embodiment, group identification information common to targets 16 each including wireless communication devices 14 to be driven is used as an instruction code. In the wireless communication system 1 in the present embodiment, the group identification information on the group to which the feature values of the feature items of the target 16 including the wireless communication device 14 belong is used as a call code.

In this manner, in the wireless communication system 1 in the present embodiment, the instruction code and the call code are not expressed by unique identification information on the wireless communication device 14, but expressed by the group identification information on the group to which the feature values of the feature items of the target 16 including the wireless communication device 14 belong. Consequently, the wireless communication system 1 in the present embodiment can reduce the limitation of selection of the wireless communication devices 14 to be driven and the limitation of the number of the wireless communication devices 14 to be driven in addition to the above-mentioned effects.

The first storage unit 22 in the information processing device 10 stores therein in advance the first information 22A in which the feature value and the group identification information are associated for each feature item. The transmission control unit 20C in the information processing device 10 transmits the instruction code, in which the group identification information on each of the feature items common to the target 16 each including the wireless communication devices 14 to be driven is disposed at a digit position set in advance for each feature item, to each of the wireless communication devices 14 capable of wireless communication.

The second storage unit 32 in the wireless communication device 14 stores therein in advance a call code in which the group identification information on the group to which the feature value of each feature item of the target 16 including the wireless communication device 14 belongs is disposed at a digit position set in advance for each feature item. When the acquired instruction code matches the call code, the drive control unit 30D in the wireless communication device 14 drives the drive unit 36.

Thus, in the wireless communication system 1 in the present embodiment, an instruction code for selectively driving wireless communication devices 14 included in targets 16 having feature values belonging to a group identified by group identification information on a plurality of kinds of various feature items can be transmitted to the wireless communication devices 14. Consequently, the wireless communication system 1 in the present embodiment can reduce the limitation of selection of the wireless communication devices 14 to be driven and the limitation of the number of the wireless communication devices 14 to be driven in addition to the above-mentioned effects.

The numbers of the digits of the instruction code and the call code are the same and equal to or smaller than a predetermined number of digits. In this manner, in the wireless communication system 1 in the present embodiment, a code having a predetermined number of digits can be used to simultaneously drive wireless communication devices 14, and hence the wireless communication devices 14 can be simultaneously driven with a small amount of data and a small amount of communication.

At least one piece of the group identification information included in the instruction code is a wildcard. Thus, for at least one feature item, a wireless communication device 14 provided to a target 16 having a feature value belonging to a group identified by all pieces of the group identification information can be designated as a target to be driven. Consequently, the wireless communication system 1 in the present embodiment can reduce the limitation of selection of the wireless communication devices 14 to be driven and the limitation of the number of the wireless communication devices 14 to be driven in addition to the above-mentioned effects.

Hardware Configuration

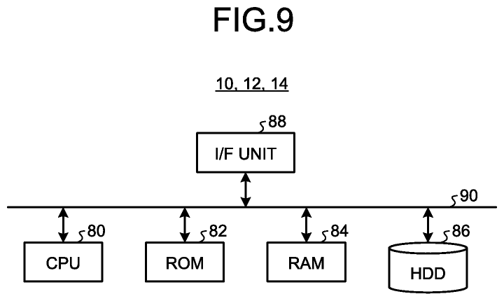

Next, an example of the hardware configuration of the information processing device 10, the observation device 12, and the wireless communication device 14 in the above-mentioned embodiment is described. FIG. 9 is a diagram illustrating an example of a hardware configuration diagram of the information processing device 10, the observation device 12, and the wireless communication device 14.

The information processing device 10, the observation device 12, and the wireless communication device 14 include a control device such as a CPU 80, storage devices such as a read-only memory (ROM) 82, a random-access memory (RAM) 84, and a hard disk drive (HDD) 86, an I/F unit 88 as an interface for various kinds of devices, and a bus 90 for connecting the units, and have a hardware configuration using a general computer.

In the information processing device 10, the observation device 12, and the wireless communication device 14, the CPU 80 reads a computer program from the ROM 82 onto the RAM 84 and executes the computer program, so that each of the above-mentioned units is implemented on the computer.

Computer programs for executing each piece of the above-mentioned processing executed by the information processing device 10, the observation device 12, and the wireless communication device 14 may be stored in the HDD 86. The computer programs for executing each piece of the above-mentioned processing executed by the information processing device 10, the observation device 12, and the wireless communication device 14 may be provided by being incorporated in the ROM 82 in advance.

The computer programs for executing the above-mentioned processing executed by the information processing device 10, the observation device 12, and the wireless communication device 14 may be stored in a computer-readable storage medium, such as a CD-ROM, a CD-R, a memory card, a digital versatile disc (DVD), and a flexible disk (FD), as a file in an installable format or an executable format, and provided as a computer program product. Computer programs for executing the above-mentioned processing executed by the information processing device 10, the observation device 12, and the wireless communication device 14 may be stored on a computer connected to a network such as the Internet, and provided by being downloaded through the network. The computer programs for executing the above-mentioned processing executed by the information processing device 10, the observation device 12, and the wireless communication device 14 may be provided or distributed through a network such as the Internet.

According to the above-mentioned aspect of the present invention, a plurality of wireless communication devices can be simultaneously driven.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication system comprising:
an information processing device; and
wireless communication devices for communicating with the information processing device by wireless communication,
the information processing device comprising:
a first storage unit that stores therein first information in which feature values of feature items of targets each including one of the wireless communication devices are associated with group identification information on groups to which the feature values belong; and
processing circuitry that implements
a transmission control unit for transmitting an instruction code including group identification information common to targets each including one of wireless communication devices to be driven, to the wireless communication devices,
each wireless communication device comprising:
a second storage unit that stores therein group identification information on groups to which feature values of the feature items of a target including the wireless communication device belong, as a call code for the wireless communication device; and
processing circuitry that implements:
an acquisition unit for acquiring the instruction code; and
a drive control unit for driving a drive unit in the wireless communication device, when the group identification information included in the acquired instruction code matches the call code.

2. The wireless communication system according to claim 1, wherein
the first storage unit stores therein the first information in which the feature values and the group identification information are associated with each other for each of the feature items,
the transmission control unit transmits the instruction code, in which the group identification information on each of the feature items, the group identification information that is common to the targets each including one of the wireless communication devices to be driven, is disposed at a digit position set in advance for each of the feature items, to each of the wireless communication devices,
the second storage unit stores therein the call code in which group identification information on a group to which a feature value of each of the feature items of the target including the wireless communication device is disposed at a digit position set in advance for each of the feature items, and
the drive control unit drives the drive unit when the acquired instruction code matches the call code.

3. The wireless communication system according to claim 2, wherein numbers of digits of the instruction code and the call code are the same and equal to or smaller than a predetermined number of digits.

4. The wireless communication system according to claim 1, wherein at least one piece of the group identification information included in the instruction code is a wildcard.

5. A computer program product including programmed instructions embodied in and stored on a non-transitory computer readable medium, the instructions cause a computer that communicates with wireless communication devices to
transmit an instruction code including group identification information on groups to which feature values of feature items of targets each including one of wireless communication devices to be driven belong, the group identification information that is common to the targets, to each of the wireless communication devices.
